(19) United States
(12) Patent Application Publication
(10) Pub. No.: US 2026/0131705 A1
(43) Pub. Date: May 14, 2026

(54) VEHICLE SEAT AND METHOD OF MANUFACTURING THE SAME

(71) Applicant: TS TECH CO., LTD., Asaka-shi (JP)

(72) Inventor: Tatsuro OGAWA, Tochigi (JP)

(21) Appl. No.: 19/381,416

(22) Filed: Nov. 6, 2025

Related U.S. Application Data
(60) Provisional application No. 63/855,748, filed on Nov. 6, 2025.
(60) Provisional application No. 63/716,841, filed on Nov. 6, 2024.

(51) Int. Cl. B60N 2/235; B60N 2/22

(52) U.S. Cl. CPC B60N 2/2362; B60N 2/2236

(57) ABSTRACT

A vehicle seat includes a first member, a second member, and a pivot device configured to connect the second member angularly adjustably to the first member. The pivot device includes a pair of rotating members that are rotatably connected to each other and form an outer shell of the pivot device, an operating shaft that passes through central holes formed respectively in the pair of rotating members, a seal member supported by the operating shaft and configured to seal a clearance between the operating shaft and each central hole, a cover supported by the operating shaft and configured to hold the seal member between the cover and each rotating member. One of the pair of rotating members is coupled to the first member, and the other of the pair of rotating members is coupled to the second member.

### CROSS-REFERENCE TO RELATED APPLICATIONS

The present application is based upon and claims the right of priority to U.S. Provisional Patent Application No. 63/855,748, filed on August 1, 2025, and U.S. Provisional Patent Application No. 63/716,841, filed on November 6, 2024, the disclosures of which are hereby incorporated by reference herein in their entireties for all purposes.

### TECHNICAL FIELD

The present invention relates to a vehicle seat and a method of manufacturing the same.

### BACKGROUND ART

Patent Document 1 (US 2013/0090204 A1) discloses a pivot device (reclining device) for a vehicle seat. The pivot device includes a first fitting part that is joined to a seat back, a second fitting part that is rotatably supported by the first fitting part and joined to a seat cushion, an eccentric cam provided between the first fitting part and the second fitting part, and a driver configured to drive the eccentric cam. The first fitting part has a toothed ring, and the second fitting part has a toothed wheel that meshes with the toothed ring. The eccentric cam is rotationally driven by the driver to cause a rolling motion between the toothed wheel and the toothed ring, thereby continuously adjusting the angle of the seat back. Through holes are formed at the centers of the first fitting part and the second fitting part, and the driver is inserted into the through holes. A clearance between the driver and each through hole is sealed by a securing ring and a sealing ring, and grease is enclosed in the internal spaces of the first fitting part and the second fitting part.

In vehicles such as all-terrain vehicles (ATVs), the vehicle seat is exposed to the outside environment. Therefore, rainwater is likely to splash onto the pivot device, and there is also a risk that a water stream will directly hit the pivot device during washing. Accordingly, the pivot device is required to have a seal structure with higher reliability.

### SUMMARY OF THE INVENTION

In view of the above background, an object of one aspect of the present invention is to improve the watertightness of a pivot device in a vehicle seat.

To achieve such an object, one aspect of the present invention provides a vehicle seat, comprising: a first member; a second member; and a pivot device configured to connect the second member angularly adjustably to the first member, wherein the pivot device includes: a pair of rotating members that are rotatably connected to each other and form an outer shell of the pivot device; a lock member disposed between the pair of rotating members and configured to move between a lock position, in which relative rotation of the pair of rotating members is restricted, and a release position, in which relative rotation of the pair of rotating members is permitted; an operating shaft that passes through central holes formed respectively in the pair of rotating members and is configured to rotate to displace the lock member between the lock position and the release position; a seal member supported by the operating shaft and configured to seal a clearance between the operating shaft and each central hole; and a cover supported by the operating shaft and configured to hold the seal member between the cover and each rotating member, wherein one of the pair of rotating members is joined to the first member, and the other of the pair of rotating members is joined to the second member.

Another aspect of the present invention provides a method of producing a vehicle seat, wherein the vehicle seat includes: a seat cushion frame; a seat back frame; and a pivot device configured to connect the seat back frame angularly adjustably to the seat cushion frame, the pivot device including: a pair of rotating members that are rotatably connected to each other and form an outer shell of the pivot device; a lock member disposed between the pair of rotating members and configured to move between a lock position, in which relative rotation of the pair of rotating members is restricted, and a release position, in which relative rotation of the pair of rotating members is permitted; an operating shaft that passes through central holes formed respectively in the pair of rotating members and is configured to rotate to displace the lock member between the lock position and the release position; the method comprising: mounting one of the pair of rotating members to the seat cushion frame; mounting the other of the pair of rotating members to the seat back frame; mounting a seal member on the operating shaft to seal a clearance between the operating shaft and each of the central holes by the seal member; and mounting a cover on the operating shaft to hold the seal member between the cover and the rotating member.

Thus, according to the above aspects, it is possible to improve the watertightness of the pivot device in the vehicle seat.

### BRIEF DESCRIPTION OF THE DRAWING(S)

FIG. 1 is a perspective view of a vehicle seat according to an embodiment;

FIG. 2 is a perspective view of a frame of the vehicle seat;

FIG. 3 is an exploded perspective view of a main portion of the vehicle seat;

FIG. 4 is an exploded perspective view of a pivot device;

FIG. 5 is an explanatory view showing a rotation-restricted state of the pivot device;

FIG. 6 is an explanatory view showing a rotation-allowable state of the pivot device;

FIG. 7 is a sectional view of the pivot device;

FIG. 8 is an enlarged view of a main portion of FIG. 7;

FIG. 9 is a perspective view of a first seal member viewed from the outside;

FIG. 10 is a perspective view of the first seal member viewed from the inside;

FIG. 11 is a perspective view of a first cover viewed from the outside;

FIG. 12 is a perspective view of the first cover viewed from the inside;

FIG. 13 is a side view of a lower support portion viewed from the left side; and

FIG. 14 is a side view of the lower support portion viewed from the left side, with a spiral spring and the first cover omitted.

### DETAILED DESCRIPTION OF THE INVENTION

In the following, an embodiment of a vehicle seat will be described with reference to the drawings. A vehicle on which the vehicle seat is mounted may be, for example, an all-terrain vehicle (ATV).

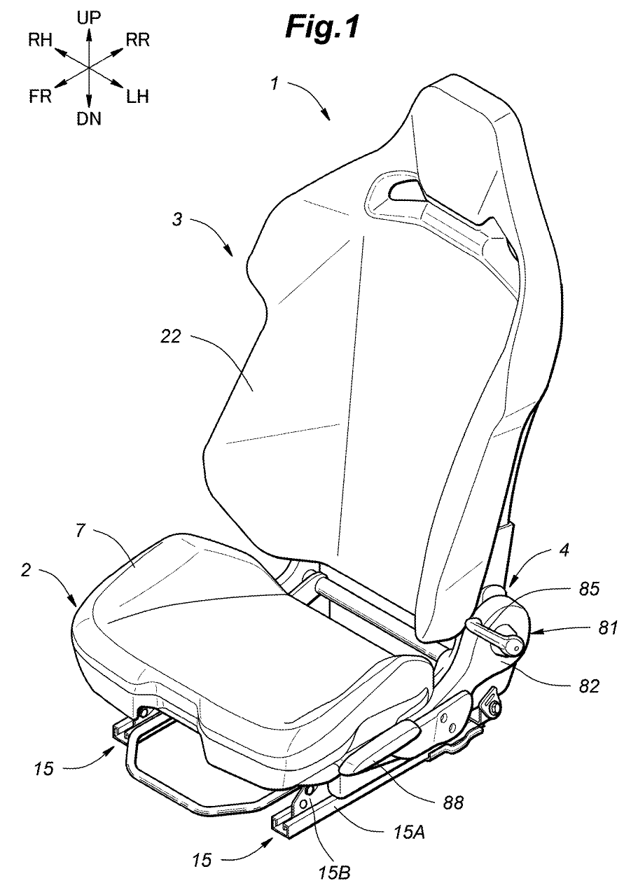

As shown in FIG. 1, a vehicle seat 1 includes a seat cushion 2 as a first member, a seat back 3 as a second member, and a pivot device 4 configured to connect the seat back 3 angularly adjustably to the seat cushion 2. The seat cushion 2 supports the hips of a user from below. The seat back 3 extends upward from a rear portion of the seat cushion 2.

The seat back 3 supports the back of the user from behind.

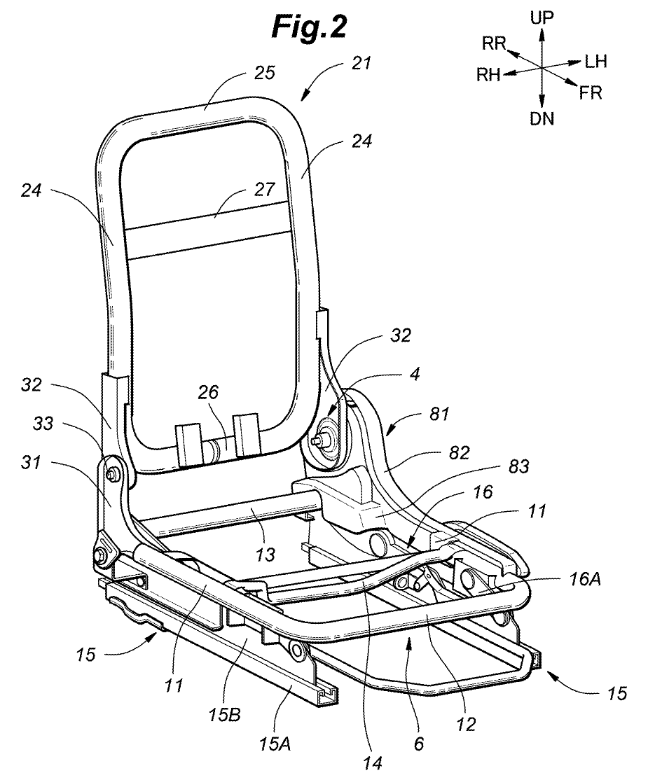

As shown in FIG. 2, the seat cushion 2 includes a seat cushion frame 6 that forms a skeletal structure, and a pad 7 supported by the seat cushion frame 6. The pad 7 is covered with a skin material. The seat cushion frame 6 includes left and right seat cushion side members 11 extending in a front-rear direction, a front member 12 extending in a left-right direction and coupled to front ends of the left and right seat cushion side members 11, a rear member 13 extending in a left-right direction and coupled to rear ends of the left and right seat cushion side members 11, and a seat cushion middle member 14 extending in a left-right direction between the front member 12 and the rear member 13 and coupled to front ends of the left and right seat cushion side members 11. The pad 7 may be detachably supported by the seat cushion 2.

The seat cushion frame 6 is supported on a floor via a slide device 15 and a lift device 16. The slide device 15 includes left and right lower rails 15A extending in a front-rear direction and left and right upper rails 15B that are supported on the respective lower rails 15A so as to be movable in the front-rear direction. The lift device 16 includes a plurality of links 16A that couple the left and right seat cushion side members 11 to the left and right upper rails 15B so as to be vertically movable, and a lift lock device 16B that restricts rotation of the links 16A. In another embodiment, the slide device 15 and the lift device 16 may be omitted, and the left and right seat cushion side members 11 may be directly coupled to the floor.

The seat back 3 includes a seat back frame 21 that forms a skeletal structure and a pad 22 supported by the seat back frame 21. The pad 22 is covered with a skin material.

The seat back frame 21 includes left and right seat back side members 24 extending in an up-down direction, an upper member 25 extending in a left-right direction and coupled to upper ends of the left and right seat back side members 24, a lower member 26 extending in a left-right direction and coupled to lower ends of the left and right seat back side members 24, and a seat back middle member 27 extending in a left-right direction between the upper member 25 and the lower member 26 and coupled to the left and right seat back side members 24.

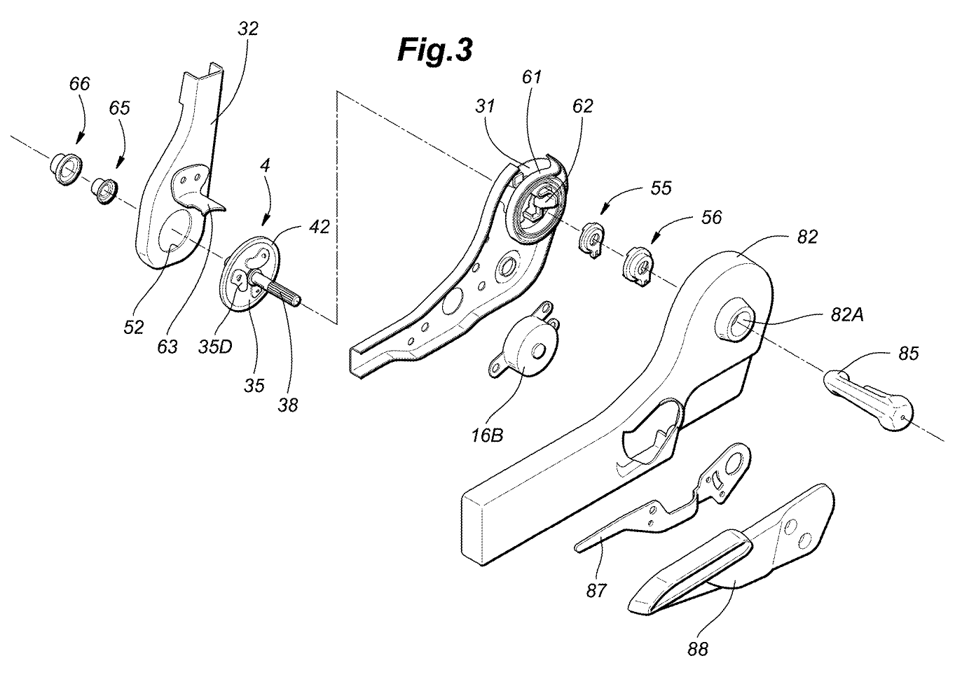

As shown in FIGS. 2 and 3, left and right lower support portions 31 that protrude upward are provided at rear end portions of the left and right seat cushion side members 11.

Left and right upper support portions 32 that protrude downward are provided at lower end portions of the left and right seat back side members 24. Each of the left and right lower support portions 31 and the left and right upper support portions 32 is formed as a plate-like member facing in a left-right direction.

As shown in FIG. 2, the right upper support portion 32 is disposed to face the right lower support portion 31 and is rotatably supported by the right lower support portion 31 via a support shaft 33 extending in a left-right direction. The left upper support portion 32 is rotatably supported by the left lower support portion 31 via the pivot device 4. Rotational axes of the left and right upper support portions 32 extend in the left-right direction and are arranged coaxially with each other.

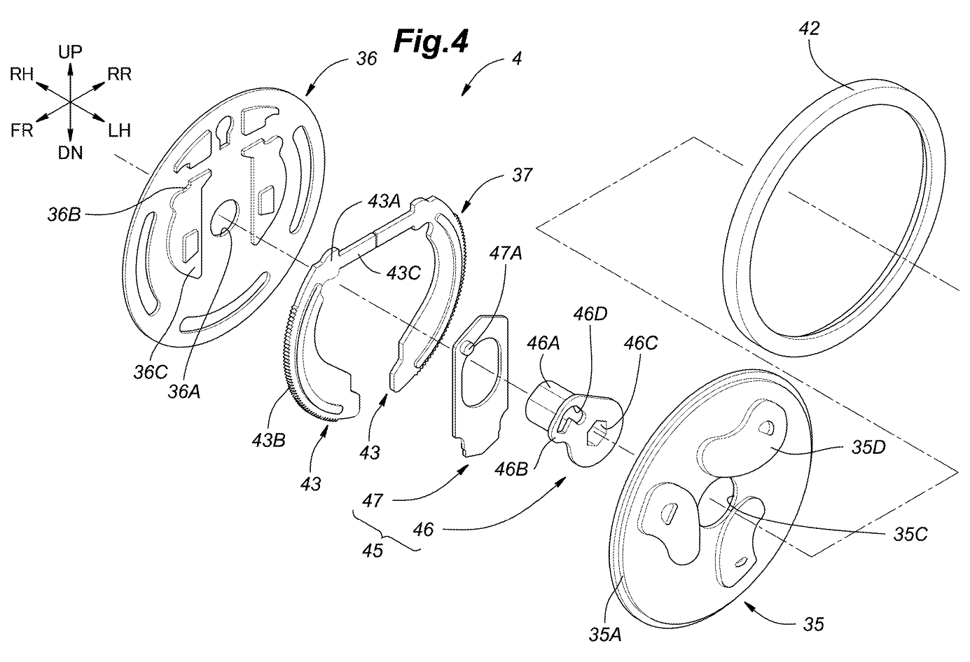

As shown in FIG. 4, the pivot device 4 includes a first rotating member 35, a second rotating member 36, a lock member 37, and an operating shaft 38. The first rotating member 35 and the second rotating member 36 are rotatably coupled to each other and form an outer shell of the pivot device 4. The first rotating member 35 and the second rotating member 36 are each formed in a disk shape and are disposed to face each other.

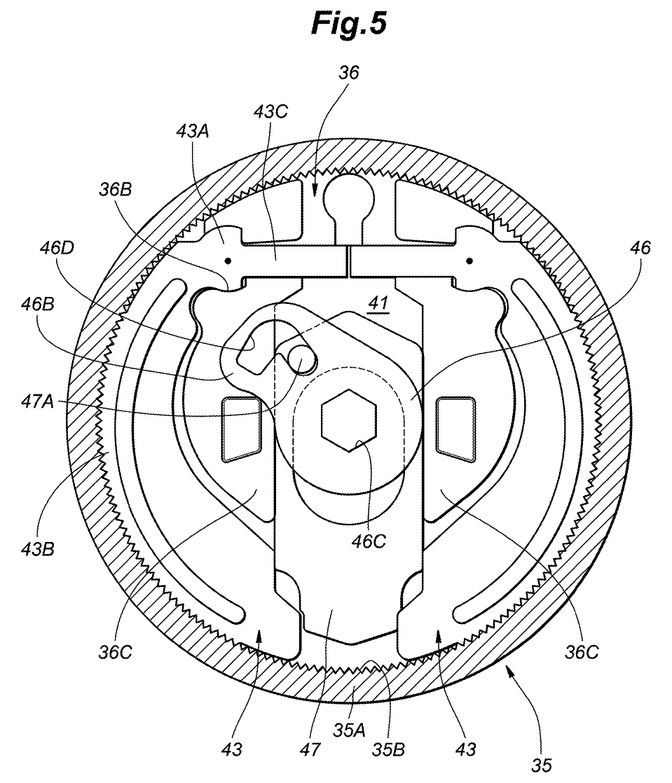

As shown in FIG. 5, a cylindrical edge wall 35A is provided on an outer peripheral edge of the first rotating member 35. The edge wall 35A protrudes toward the second rotating member 36. Internal teeth 35B are formed on an inner peripheral surface of the edge wall 35A. An internal space 41 is formed between the first rotating member 35 and the second rotating member 36. As shown in FIG. 4, a ring 42 is attached to outer peripheral edges of the first rotating member 35 and the second rotating member 36. The ring 42 rotatably couples the first rotating member 35 and the second rotating member 36. The ring 42 may be welded to either the first rotating member 35 or the second rotating member 36. A first central hole 35C penetrating in a thickness direction is formed at a central portion of the first rotating member 35. A second central hole 36A penetrating in a thickness direction is formed at a central portion of the second rotating member 36.

As shown in FIGS. 4 and 5, the lock member 37 is disposed between the first rotating member 35 and the second rotating member 36, that is, in the internal space 41.

The lock member 37 is configured to move between a lock position, in which the lock member 37 meshes with the first rotating member 35 and the second rotating member 36 to restrict relative rotation of the first rotating member 35 and the second rotating member 36, and a release position, in which relative rotation of the first rotating member 35 and the second rotating member 36 is permitted.

The operating shaft 38 penetrates through the first central hole 35C formed in the first rotating member 35 and the second central hole 36A formed in the second rotating member 36. The operating shaft 38 is configured to displace the lock member 37 between a lock position and a release position by rotation. Accordingly, by rotating the operating shaft 38, a user can switch the pivot device 4 between a rotation-allowable state in which rotation is permitted and a rotation-restricted state in which rotation is restricted, that is, can switch the seat back 3 relative to the seat cushion 2 between the rotation-allowable state and the rotation-restricted state.

The lock member 37 may include a pair of lock pieces 43. Each lock piece 43 is formed symmetrically with respect to the other. Each lock piece 43 includes a rotating shaft portion 43A that is rotatably supported by a bearing portion 36B provided on the second rotating member 36, an engagement portion 43B that extends from the rotating shaft portion 43A along the internal teeth 35B, and an operating portion 43C that extends from the rotating shaft portion 43A in a direction opposite to the engagement portion 43B. Each lock piece 43 rotates about the rotating shaft portion 43A, thereby changing between a state in which the engagement portion 43B is engaged with the internal teeth 35B and a state in which the engagement portion 43B is disengaged from the internal teeth 35B. When the engagement portion 43B engages with the internal teeth 35B, relative rotation between the first rotating member 35 and the second rotating member 36 is restricted, and when the engagement portion 43B is disengaged from the internal teeth 35B, relative rotation between the first rotating member 35 and the second rotating member 36 is permitted.

A rotational force of the operating shaft 38 may be transmitted to the lock member 37 by a cam 45. The cam 45 may include a first cam 46 that is coupled to the operating shaft 38 and rotates integrally with the operating shaft 38, and a second cam 47 that linearly moves in accordance with a rotational movement of the first cam 46 and acts on the pair of lock pieces 43. The first cam 46 and the second cam 47 are disposed in the internal space 41.

The first cam 46 includes a cylindrical portion 46A to which the operating shaft 38 is coupled, and an arm portion 46B that extends radially from the cylindrical portion 46A. An inner hole 46C through which the operating shaft 38 penetrates and fits is formed in the cylindrical portion 46A. A cam groove 46D is formed in the arm portion 46B.

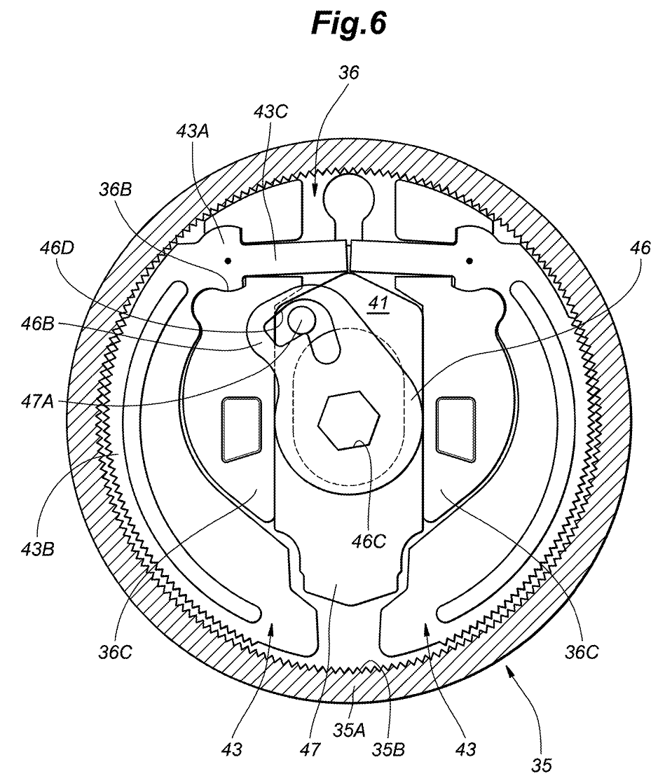

As shown in FIGS. 5 and 6, the second cam 47 is guided by a guide wall 36C provided on the second rotating member 36 and linearly moves between a first position and a second position. The second cam 47 has a pin 47A that engages with the cam groove 46D. When the operating shaft 38 and the first cam 46 rotate, the pin 47A is pushed by the cam groove 46D, and the second cam 47 moves between the first position and the second position. As shown in FIG. 5, when the second cam 47 is in the first position, the second cam 47 fits between the pair of engagement portions 43B and comes into contact with the engagement portions 43B to maintain engagement portions 43B in a state engaged with the internal teeth 35B. When the second cam 47 moves from the second position to the first position, as shown in FIG. 6, the second cam 47 moves away from the pair of engagement portions 43B while pressing the pair of operating portions 43C to rotate the pair of lock pieces 43. As a result, the pair of engagement portions 43B are disengaged from the internal teeth 35B, thereby allowing relative rotation between the first rotating member 35 and the second rotating member 36.

The lock member 37 is biased toward the lock position. A biasing member that biases the lock member 37 toward the lock position may be disposed in the internal space 41. The biasing member may directly bias the lock member 37, or may bias the lock member 37 through at least one of the first cam 46, the second cam 47, and the operating shaft 38.

As shown in FIGS. 3, 7, and 8, an outer surface of the first rotating member 35 is coupled to a right surface of the left lower support portion 31, and an outer surface of the second rotating member 36 is coupled to a left surface of the left upper support portion 32.

The left lower support portion 31 has a lower mounting hole 51 that penetrates in a left-right direction. A central portion of the outer surface of the first rotating member 35 is exposed leftward through the lower mounting hole 51. The left upper support portion 32 has an upper mounting hole 52 that penetrates in the left-right direction. A central portion of the outer surface of the second rotating member 36 is exposed rightward through the upper mounting hole 52.

At a portion of the first rotating member 35 facing the lower mounting hole 51, a plurality of projections 35D is formed. These projections 35D are arranged around the first central hole 35C with spaces between each other. These projections 35D increase the rigidity of the first rotating member 35. Each of projections 35D may engage with an edge portion of the lower mounting hole 51 in a circumferential direction.

The pivot device 4 includes a first seal member 55 that is supported by the operating shaft 38 and seals a clearance between the operating shaft 38 and the first central hole 35C, and a first cover 56 that is supported by the operating shaft 38 and holds the first seal member 55 between the first cover 56 and the first rotating member 35.

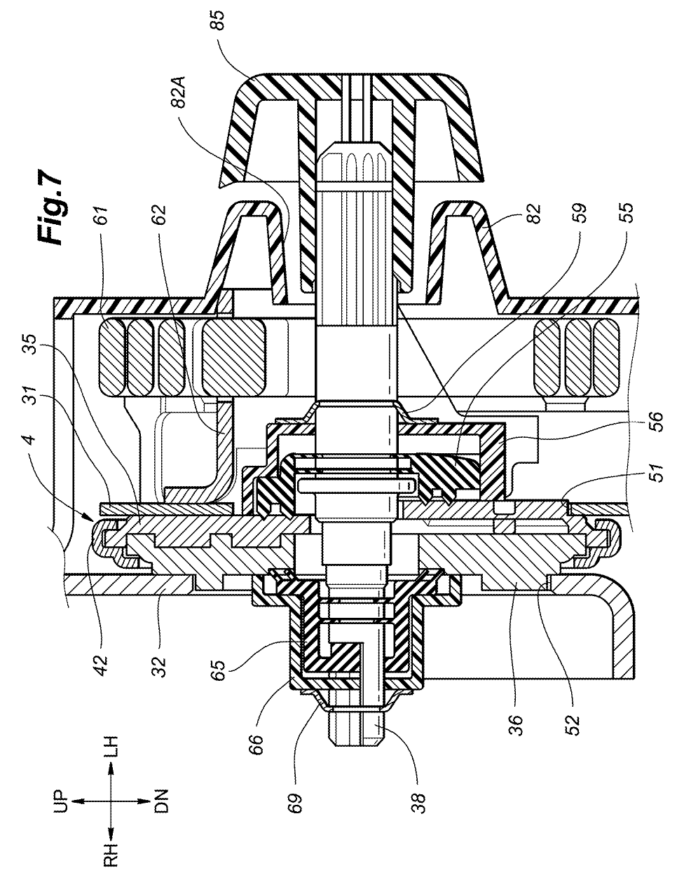

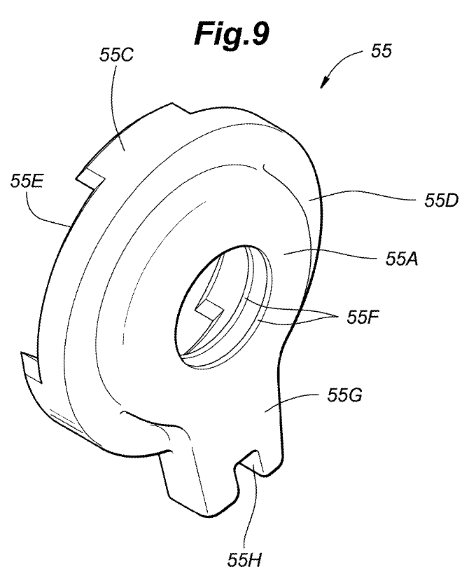

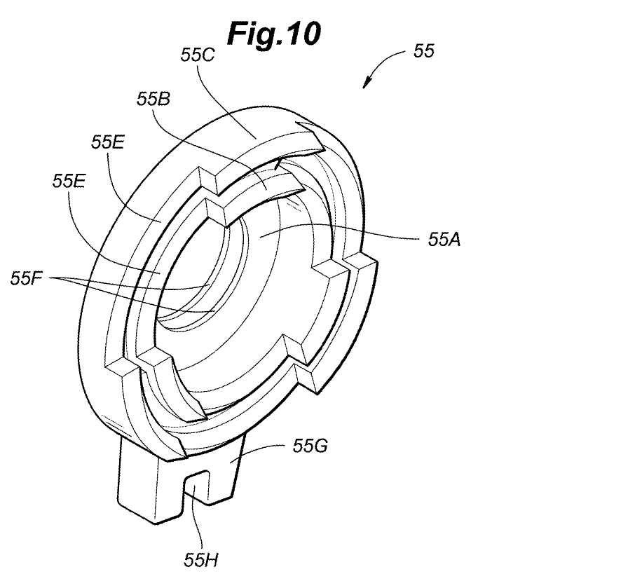

As shown in FIGS. 7 to 9 and 10, the first seal member 55 includes an annular seal main body 55A through which the operating shaft 38 penetrates, and an inner thrust lip 55B and an outer thrust lip 55C that protrude from the seal main body 55A, come into contact with the first rotating member 35, and seal a clearance. The seal main body 55A has a flange portion 55D that extends radially outward at an end portion on the side of the first rotating member 35. The inner thrust lip 55B and the outer thrust lip 55C are provided on the flange portion 55D. The inner thrust lip 55B and the outer thrust lip 55C protrude in an axial direction of the operating shaft 38 and extend annularly about the operating shaft 38. The inner thrust lip 55B is disposed inside the outer thrust lip 55C. The inner thrust lip 55B and the outer thrust lip 55C are thinner in thickness than the seal main body 55A and have higher flexibility than the seal main body 55A.

The inner thrust lip 55B and the outer thrust lip 55C have complementary shapes corresponding to an uneven structure formed by the plurality of projections 35D of the first rotating member 35 and are capable of closely contacting the uneven structure. For example, the inner thrust lip 55B and the outer thrust lip 55C have a plurality of recesses 55E into which the plurality of projections 35D fit. Accordingly, the sealing performance at a contact surface between the inner thrust lip 55B and the outer thrust lip 55C and the first rotating member 35 is enhanced, thereby effectively preventing intrusion of water or foreign matter. Tip portions of the inner thrust lip 55B and the outer thrust lip 55C are formed to be tapered, thereby increasing flexibility. An annular groove 35E for receiving the tip portions of the inner thrust lip 55B and the outer thrust lip 55C may be formed on the outer surface of the first rotating member 35.

The seal main body 55A has a plurality of annular radial lips 55F that protrude from the seal main body 55A toward the operating shaft 38 and are capable of sliding contact with an outer circumferential surface of the operating shaft 38. Each of radial lips 55F may be formed thinner than each of the inner thrust lip 55B and the outer thrust lip 55C. Each of radial lips 55F extends radially inward from the seal main body 55A and comes into close contact with the outer circumferential surface of the operating shaft 38 to seal a clearance. Accordingly, water or foreign matter entering the internal space 41 from the outer circumferential side of the operating shaft 38 can be more reliably prevented.

A plurality of annular engagement grooves 38A extending in a circumferential direction are formed on an outer circumferential surface of the operating shaft 38. Each of radial lips 55F projects into a corresponding engagement groove 38A. Accordingly, displacement or lifting of radial lips 55F is suppressed, and a close contact state between radial lips 55F and the operating shaft 38 is stably maintained. As a result, the sealing performance of the pivot device 4 can be further improved.

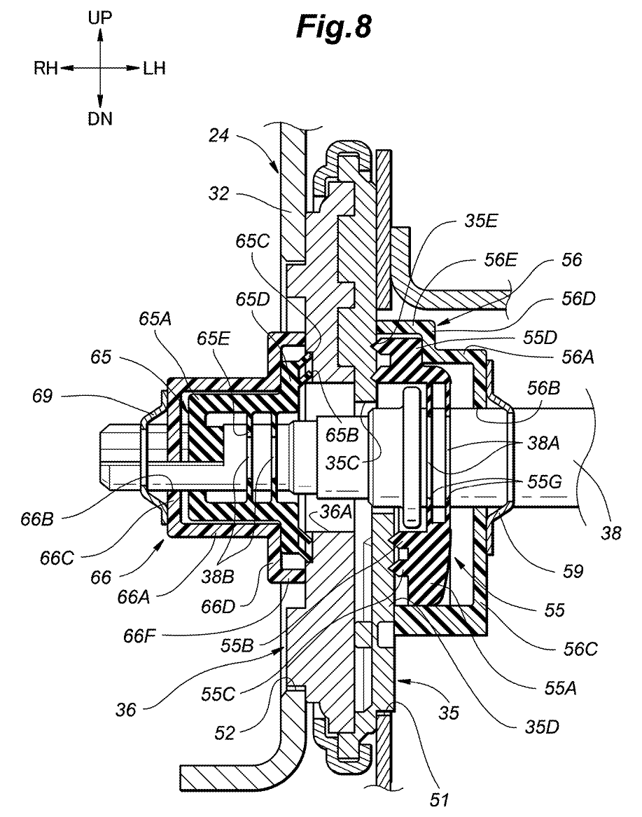

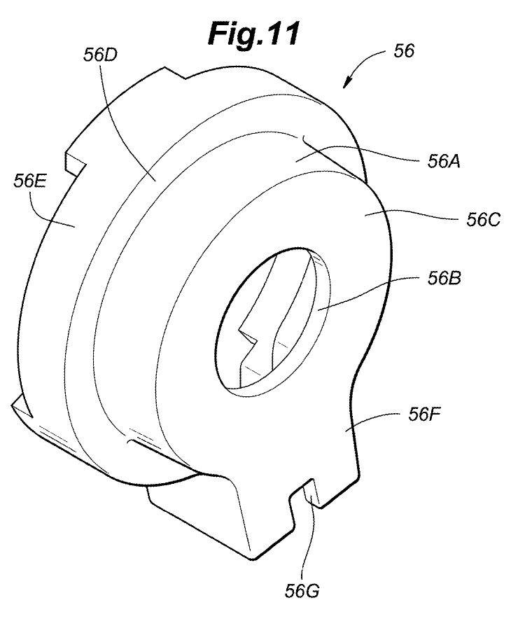

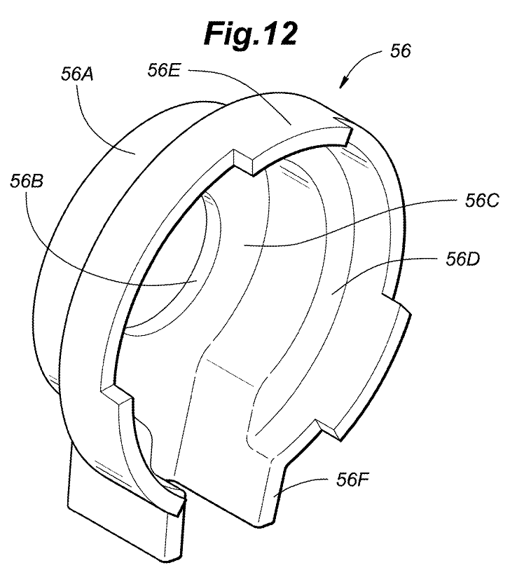

As shown in FIGS. 8, 11, and 12, the first cover 56 includes a cylindrical portion 56A, an end wall portion 56C provided at one end of the cylindrical portion 56A and having a shaft hole 56B through which the operating shaft 38 penetrates, a flange portion 56D that protrudes radially outward from the other end of the cylindrical portion 56A, and an edge wall portion 56E that protrudes from the flange portion 56D in a direction opposite to the cylindrical portion 56A. The first seal member 55 is received in a space surrounded by the cylindrical portion 56A, the end wall portion 56C, the flange portion 56D, and the edge wall portion 56E.

The first cover 56 is supported on the operating shaft 38 by a push nut 59 that is coupled to the operating shaft 38. The push nut 59 keeps the edge wall portion 56E in contact with the first rotating member 35. The edge wall portion 56E has a complementary shape corresponding to an uneven structure formed by the plurality of projections 35D of the first rotating member 35 and is capable of closely contacting the uneven structure. The first seal member 55 is clamped between the flange portion 56D and the first rotating member 35 and is stably held. Accordingly, displacement or detachment of the first seal member 55 can be prevented and sealing performance around the operating shaft 38 can be maintained over a long period of time.

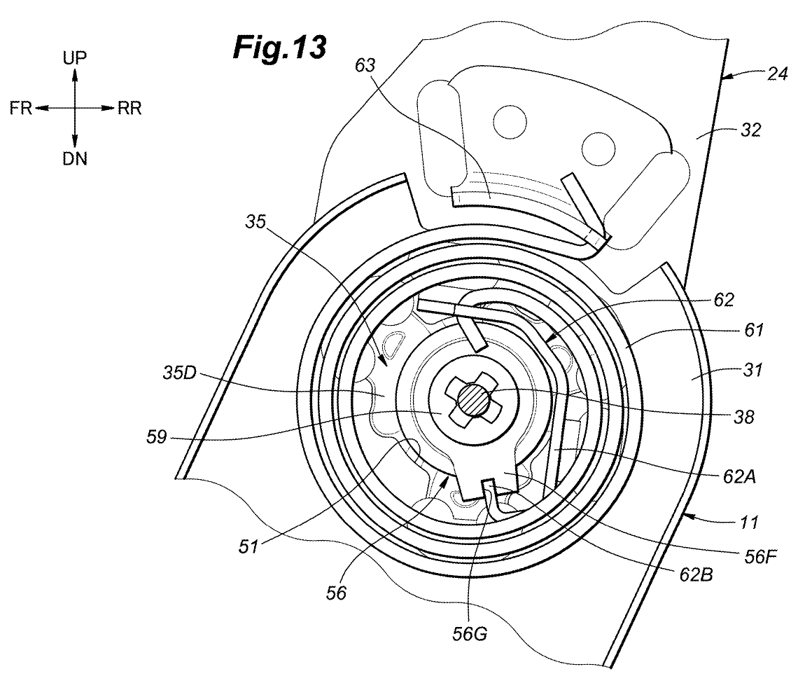

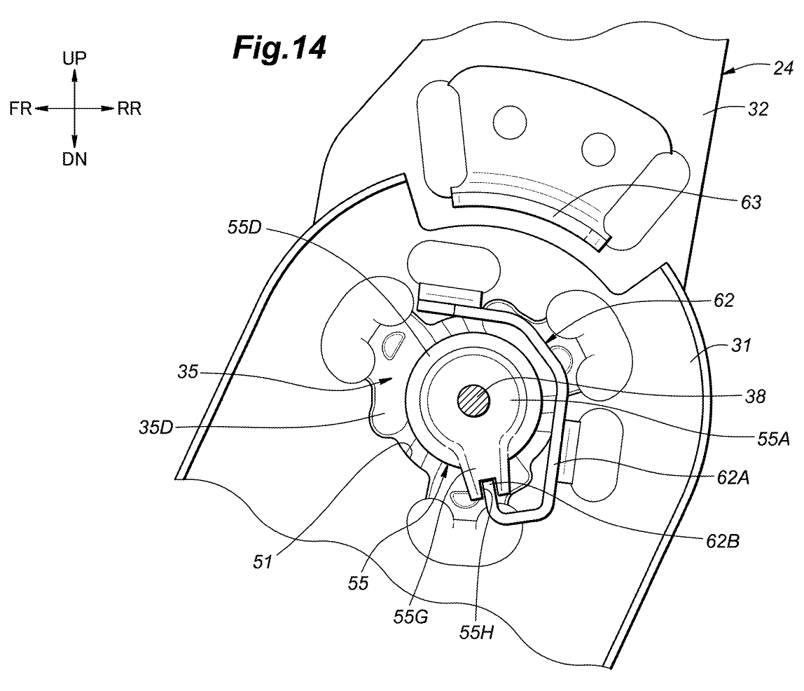

As shown in FIGS. 8 and 13, a spiral spring 61 is provided between the seat cushion frame 6 and the seat back frame 21. The spiral spring 61 biases the seat back frame 21 forward relative to the seat cushion frame 6. The lower support portion 31 is provided with a lower spring retaining portion 62 that supports one end of the spiral spring 61, and the upper support portion 32 is provided with an upper spring retaining portion 63 that supports the other end of the spiral spring 61. As shown in FIGS. 13 and 14, the lower spring retaining portion 62 is formed by a metal piece welded to an outer surface of the lower support portion 31. The lower spring retaining portion 62 protrudes leftward from above the lower mounting hole 51 on a left surface of the lower support portion 31. The lower spring retaining portion 62 has an extension portion 62A extending downward while being bent. The extension portion 62A extends along an edge portion of the lower mounting hole 51 to a lower part of the lower mounting hole 51. A lower end 62B of the extension portion 62A is bent and extends upward.

A seal extension portion 55G extending downward is provided at the lower end of the seal main body 55A. The seal extension portion 55G extends radially outward from the outer thrust lip 55C. At the lower end of the seal extension portion 55G, a seal-side lock hole 55H recessed upward is formed. Similarly, a cover extension portion 56F extending downward is provided at the lower end of the cylindrical portion 56A of the first cover 56. The cover extension portion 56F extends radially outward from the edge wall portion 56E. A cover-side lock hole 56G recessed upward is formed at a lower end of the edge wall portion 56E. A lower end of the extension portion 62A projects into the seal-side lock hole 55H and the cover-side lock hole 56G. The lower end 62B of the extension portion 62A locks the seal-side lock hole 55H and the cover-side lock hole 56G, thereby restricting rotation of the first seal member 55 and the first cover 56 relative to the first rotating member 35. Accordingly, displacement of the first seal member 55 is prevented, and the clearance between the first central hole 35C and the operating shaft 38 is reliably sealed.

As shown in FIGS. 3 and 8, the pivot device 4 includes a second seal member 65 that is supported by the operating shaft 38 and seals a clearance between the operating shaft 38 and the second central hole 36A, and a second cover 66 that is supported by the operating shaft 38 and holds the second seal member 65 between the second cover 66 and the second rotating member 36.

The second seal member 65 includes an annular seal main body 65A through which the operating shaft 38 penetrates, and an inner thrust lip 65B and an outer thrust lip 65C that protrude from the seal main body 65A, come into contact with the second rotating member 36. The seal main body 65A is formed in a cylindrical shape. The seal main body 65A has a flange portion 65D that extends radially outward in a disk shape at an end portion on the side of the second rotating member 36. The inner thrust lip 65B and the outer thrust lip 65C are provided on the flange portion 65D. The inner thrust lip 65B and the outer thrust lip 65C protrude in an axial direction of the operating shaft 38 and extend annularly about the operating shaft 38. The inner thrust lip 65B is disposed inside the outer thrust lip 65C. The inner thrust lip 65B and the outer thrust lip 65C are thinner in thickness than the seal main body 65A and have higher flexibility than the seal main body 65A. The inner thrust lip 65B and the outer thrust lip 65C are capable of closely contacting a planar outer surface of the second rotating member 36.

The seal main body 65A has a plurality of annular radial lips 65E that protrude from the seal main body 65A toward the operating shaft 38 and are capable of sliding contact with an outer circumferential surface of the operating shaft 38. Each of radial lips 65E extends radially inward from the seal main body 65A and comes into close contact with the outer circumferential surface of the operating shaft 38. Accordingly, intrusion of water or foreign matter into the internal space 41 from an outer circumferential side of the operating shaft 38 can be more reliably prevented.

A plurality of annular engagement grooves 38B extending in a circumferential direction are formed on an outer circumferential surface of the operating shaft 38. Each of radial lips 65E projects into a corresponding engagement groove 38B. Accordingly, displacement or lifting of the radial lips 65E is suppressed, and a close contact state between the radial lips 65E and the operating shaft 38 is stably maintained. As a result, the sealing performance of the pivot device 4 can be further improved.

The second cover 66 includes a cylindrical portion 66A, an end wall portion 66C provided at one end of the cylindrical portion 66A and having a shaft hole 66B through which the operating shaft 38 penetrates, a flange portion 66D that protrudes radially outward from the other end of the cylindrical portion 66A, and an edge wall portion 66F that protrudes from the flange portion 66D in a direction opposite to the cylindrical portion 66A. The second seal member 65 is received in a space surrounded by the cylindrical portion 66A, the end wall portion 66C, the flange portion 66D, and the edge wall portion 66F. The cylindrical portion 66A and the edge wall portion 66F may be formed in a cylindrical shape.

The second seal member 65 and the second cover 66 may engage with a right end of the operating shaft 38 in a circumferential direction and rotate integrally with the operating shaft 38. The second cover 66 is supported on the operating shaft 38 by a push nut 69 that is coupled to the operating shaft 38. The push nut 69 keeps the edge wall portion 66F in contact with the second rotating member 36. The second seal member 65 is clamped between the flange portion 66D and the second rotating member 36 and is stably held. Accordingly, displacement or detachment of the second seal member 65 can be prevented and sealing performance around the operating shaft 38 can be maintained over a long period of time.

Grease may be applied to a contact portion between the first rotating member 35 and the first seal member 55, and to a contact portion between the second rotating member 36 and the second seal member 65. Grease may also be applied to a contact portion between the operating shaft 38 and the first seal member 55, and to a contact portion between the operating shaft 38 and the second seal member 65. The grease may be applied to at least a part of the inner thrust lip 55B, the outer thrust lip 55C, and the radial lip 55F. The grease may also be applied to at least a part of the inner thrust lip 65B, the outer thrust lip 65C, and the radial lip 65E. Accordingly, small clearances between the seal members and the rotating members and the operating shaft 38 are filled, thereby further enhancing sealing performance, reducing sliding resistance of the lip portions, and improving durability.

As shown in FIGS. 2 and 3, an outer cover 81 is attached to the left seat cushion side member 11. The outer cover 81 is configured by combining a left outer cover 82 and a right outer cover 83. The left outer cover 82 is disposed on a left side of the seat cushion side member 11, and the right outer cover 83 is disposed on a right side of the seat cushion side member 11. When viewed from the left, the left outer cover 82 covers the lower support portion 31 and the pivot device 4. The left outer cover 82 has an insertion hole 82A through which a left end of the operating shaft 38 passes. A lever 85 is coupled to the left end of the operating shaft 38 that passes through the insertion hole 82A. By operating the lever 85, a user can rotate the operating shaft 38 and switch the pivot device 4 between a rotation-allowable state and a rotation-restricted state. Since the outer cover 81 is disposed outside the pivot device 4, water is less likely to reach the pivot device 4.

Main intrusion routes through which foreign matter enters the pivot device 4 are primarily from above and from the side of the vehicle. When the left outer cover 82 is structured to cover the pivot device 4 from above and from the side of the vehicle, the main intrusion routes of foreign matter include: (1) a route from above passing through a gap between the upper part of the left outer cover 82 and the lower support portion 31, and (2) a route from the side (left side) passing through a gap among the lever 85, operating shaft 38, and insertion hole 82A. The first seal member 55 and the first cover 56 cover the gap between the pivot device 4 and the operating shaft 38 from above by means of the outer thrust lip 55C and the edge wall portion 56E, and also cover the gap from the side by means of the radial lip 55F. As a result, not only can further intrusion of foreign matter be suppressed, but the state in which the pivot device 4, the outer thrust lip 55C, and the edge wall portion 56E are in close contact with each other is also maintained. Furthermore, the seal-side lock hole 55H and the cover-side lock hole 56G enable the first seal member 55 and the first cover 56 to be securely engaged with the lower end 62B of the lower spring retaining portion 62.

A lift lever 87 is attached to an operating shaft of the lift lock device 16B. A lever cover 88 is attached to an outer surface of the lift lever 87. By operating the lift lock device 16B, a user can make the lift lock device 16B into a released state.

A method of producing the vehicle seat 1 includes, for example, mounting the first rotating member 35 to the lower support portion 31 of the seat cushion frame 6, mounting the second rotating member 36 to the upper support portion 32 of the seat back frame 21, mounting the first seal member 55 on the operating shaft 38 to seal the clearance between the operating shaft 38 and the first central hole 35C by the first seal member 55, and mounting the first cover 56 on the operating shaft 38 to hold the first seal member 55 between the first cover 56 and the first rotating member 35. The method of producing the vehicle seat 1 may further include mounting the second seal member 65 on the operating shaft 38 to seal the clearance between the operating shaft 38 and the second central hole 36A by the second seal member 65, and mounting the second cover 66 on the operating shaft 38 to hold the second seal member 65 between the second cover 66 and the second rotating member 36.

The method of producing the vehicle seat 1 may further include mounting the outer cover 81 to the left seat cushion side member 11, and mounting the lever 85 to the operating shaft 38 that passes through the outer cover 81.

The embodiment is not limited to the above configuration and can be widely modified. In other embodiments, the pivot device 4 may be provided not only between the seat cushion 2 and the seat back 3, but also between other two members. For example, the pivot device 4 may be a lift lock device 16B provided between the upper rail 15B and the link 16A of the lift device 16. The pivot device 4 is not limited to the configuration of the above embodiments, and various configurations may be applied. The vehicle seat 1 is not limited to an all-terrain vehicle, but may also be applied to a passenger vehicle having a vehicle cabin.

The above embodiments may be described as follows:

According to one aspect, a vehicle seat 1 comprises a seat cushion frame 6 (first member), a seat back frame 21 (second member), and a pivot device 4 that connects the seat back frame 21 angularly adjustably to the seat cushion frame 6. The pivot device 4 includes a first rotating member 35 and a second rotating member 36 that are rotatably connected to each other and form an outer shell of the pivot device 4, a lock member 37 disposed between the first rotating member 35 and the second rotating member 36 and configured to move between a lock position, in which relative rotation between the first rotating member 35 and the second rotating member 36 is restricted, and a release position, in which relative rotation between the first rotating member 35 and the second rotating member 36 is permitted, an operating shaft 38 that passes through a first central hole 35C formed in the first rotating member 35 and a second central hole 36A formed in the second rotating member 36 and is configured to rotate to displace the lock member 37 between the lock position and the release position, a first seal member 55 supported by the operating shaft 38 and seals a clearance between the operating shaft 38 and the first central hole 35C, and a first cover 56 that is supported by the operating shaft 38 and holds the first seal member 55 between the first cover 56 and the first rotating member 35. One of the first rotating member 35 and the second rotating member 36 is coupled to the seat cushion frame 6, and the other of the first rotating member 35 and the second rotating member 36 is coupled to the seat back frame 21.

According to this aspect, by sealing the clearance around the operating shaft 38 with the first seal member 55 and the first cover 56, water intrusion can be effectively prevented. In addition, the first cover 56 can suppress detachment or displacement of the first seal member 55. Accordingly, the watertightness of the pivot device 4 can be improved.

Preferably, the first seal member 55 includes an annular seal main body 55A through which the operating shaft 38 extends, and a plurality of lip portions (an inner thrust lip 55B, an outer thrust lip 55C) that protrude from the seal main body 55A, come into contact with the first rotating member 35, and seal the clearance.

According to this aspect, since the plurality of lip portions come into contact with the first rotating member 35 to seal the clearance, water intrusion from around the operating shaft 38 can be more reliably prevented.

Preferably, each of the plurality of lip portions is configured to have a smaller thickness than the thickness of the seal main body 55A and is configured to have higher flexibility than the flexibility of the seal main body 55A.

According to this aspect, the lip portions, which are thinner in thickness and have higher flexibility than the seal main body 55A, can flexibly follow the first rotating member 35 and reliably seal the clearance.

Preferably, the seat cushion frame 6 includes a locking portion is configured to lock at least one of the first seal member 55 and the first cover 56, and is configured to restrict rotation of the first seal member 55 and the first cover 56 about the operating shaft 38.

According to this aspect, since the rotation of the first seal member 55 and the first cover 56 relative to the first rotating member 35 is restricted by the locking portion provided on the seat cushion frame 6, displacement of the first seal member 55 can be prevented.

Preferably the first member is the seat cushion frame 6, the second member is the seat back frame 21, the seat cushion frame 6 includes a lower spring retaining portion 62 that is configured to support a spring (spiral spring 61) for biasing the seat back frame 21 relative to the seat cushion frame 6, and the locking portion is formed by the lower spring retaining portion 62.

According to this aspect, by using the lower spring retaining portion 62 as the locking portion, rotation of the first seal member 55 and the first cover 56 can be restricted while suppressing an increase in the number of components.

Preferably, the plurality of lip portions includes an inner thrust lip 55B and an outer thrust lip 55C that protrude in an axial direction of the operating shaft 38 and extend annularly about the operating shaft 38.

According to this aspect, since the inner thrust lip 55B and the outer thrust lip 55C are brought into close contact with the first rotating member 35 in the axial direction, the first seal member 55 can be securely brought into contact with the first rotating member 35, thereby effectively preventing water intrusion.

Preferably, the plurality of lip portions includes at least one annular radial lip 55F that protrudes from the seal main body 55A toward the operating shaft 38 and configured to be capable of sliding contact with an outer circumferential surface of the operating shaft 38.

According to this aspect, since the seal member has the radial lip 55F capable of sliding contact with the operating shaft 38, the outer circumferential surface of the operating shaft 38 can also be reliably sealed.

Preferably, grease is applied to a contact portion between the first rotating member 35 and the first seal member 55.

According to this aspect, the grease can fill a clearance between the first rotating member 35 and the first seal member 55, thereby improving sealing performance.

Preferably, an annular engagement groove 38A extending in a circumferential direction is formed on an outer circumferential surface of the operating shaft 38, and the radial lip 55F projects into the engagement groove 38A.

According to this aspect, displacement and lifting of the radial lip 55F can be prevented.

Preferably, an uneven structure is formed on an outer surface of the first rotating member 35, and the inner thrust lip 55B and the outer thrust lip 55C have shapes complementary to the uneven structure and are capable of being in contact with the uneven structure.

According to this aspect, since the inner thrust lip 55B and the outer thrust lip 55C closely contact the uneven structure of the first rotating member 35 in a complementary manner, the sealing performance at the contact surface can be improved.

Preferably, the first cover 56 includes a cylindrical portion 56A, an end wall portion 56C provided at one end of the cylindrical portion 56A and having a shaft hole 56B through which the operating shaft 38 passes, a flange portion 55D that protrudes radially outward from the other end of the cylindrical portion 56A, and an edge wall portion 56E that protrudes from the flange portion 55D in a direction opposite to the cylindrical portion 56A, and the first seal member 55 is located in a housing space formed by the cylindrical portion 56A, the end wall portion 56C, the flange portion 55D, and the edge wall portion 56E, and held between the flange portion 55D and the first rotating member 35.

According to this aspect, by locating the first seal member 55 in the housing space of the first cover 56 and holding the first seal member 55 between the flange portion 55D and the first rotating member 35, the first seal member 55 can be stably held.

According to another aspect, a method of producing a vehicle seat 1, the vehicle seat 1 comprising: a seat cushion frame 6; a seat back frame 21; and a pivot device 4 configured to connect the seat back frame 21 angularly adjustably to the seat cushion frame 6, the pivot device 4 including: a first rotating member 35 and a second rotating member 36 that are rotatably connected to each other and form an outer shell of the pivot device 4; a lock member 37 disposed between the first rotating member 35 and the second rotating member 36 and configured to move between a lock position, in which relative rotation of the first rotating member 35 and the second rotating member 36 is restricted, and a release position, in which relative rotation of the first rotating member 35 and the second rotating member 36 is permitted; and an operating shaft 38 that passes through a first central hole 35C and a second central hole 36A formed respectively in the first rotating member 35 and the second rotating member 36 and is configured to rotate to displace the lock member 37 between the lock position and the release position, the method comprising: mounting the first rotating member 35 to the seat cushion frame 6; mounting the second rotating member 36 to the seat back frame 21; mounting the first seal member 55 on the operating shaft 38 to seal a clearance between the operating shaft 38 and the first central hole 35C by the first seal member 55, and mounting the first cover 56 on the operating shaft 38 to hold the first seal member 55 between the first cover 56 and the first rotating member 35.

According to this aspect, since the first seal member 55 and the first cover 56 can be assembled to the pivot device 4 in a predetermined procedure, the watertightness of the pivot device 4 of the vehicle seat 1 can be improved.

Preferably, the method of producing the vehicle seat 1 further comprises mounting an outer cover 81 to the seat cushion frame 6, and mounting a lever 85 to the operating shaft 38 that penetrates the outer cover 81.

According to this aspect, since the lever 85 is mounted to the operating shaft 38 after the outer cover 81 is mounted, an externally exposed portion of the operating shaft 38 can be reliably protected.

1. A vehicle seat, comprising:
a first member;
a second member; and
a pivot device configured to connect the second member angularly adjustably to the first member,
wherein the pivot device includes:
a pair of rotating members that are rotatably connected to each other and form an outer shell of the pivot device;
a lock member disposed between the pair of rotating members and configured to move between a lock position, in which relative rotation of the pair of rotating members is restricted, and a release position, in which relative rotation of the pair of rotating members is permitted;
an operating shaft that passes through central holes formed respectively in the pair of rotating members and is configured to rotate to displace the lock member between the lock position and the release position;
a seal member supported by the operating shaft and configured to seal a clearance between the operating shaft and each central hole; and
a cover supported by the operating shaft and configured to hold the seal member between the cover and each rotating member,
wherein one of the pair of rotating members is coupled to the first member, and the other of the pair of rotating members is coupled to the second member.

2. The vehicle seat according to claim 1, wherein the seal member includes an annular seal main body through which the operating shaft extends, and a plurality of lip portions that protrude from the seal main body and come into contact with the rotating member to seal the clearance.

3. The vehicle seat according to claim 2, wherein each of the plurality of lip portions is configured to have a smaller thickness than the thickness of the seal main body and is configured to have higher flexibility than the flexibility of the seal main body.

4. The vehicle seat according to claim 2, wherein the first member includes a lock portion that is configured to lock at least one of the seal member and the cover, and is configured to restrict rotation of the seal member and the cover about the operating shaft.

5. The vehicle seat according to claim 4, wherein the first member is a seat cushion frame, the second member is a seat back frame, the seat cushion frame includes a spring retaining portion that is configured to support a spring for biasing the seat back frame relative to the seat cushion frame, and the lock portion is formed by the spring retaining portion.

6. The vehicle seat according to claim 2, wherein the plurality of lip portions includes an inner thrust lip and an outer thrust lip that protrude in an axial direction of the operating shaft and extend annularly about the operating shaft.

7. The vehicle seat according to claim 6, wherein the plurality of lip portions includes at least one annular radial lip that protrudes from the seal main body toward the operating shaft and is configured to be capable of sliding contact with an outer circumferential surface of the operating shaft.

8. The vehicle seat according to claim 7, wherein grease is applied to a contact portion between the rotating member and the seal member.

9. The vehicle seat according to claim 7, wherein an annular engagement groove extending in a circumferential direction is formed on an outer circumferential surface of the operating shaft, and the radial lip projects into the engagement groove.

10. The vehicle seat according to claim 6, wherein an uneven structure is formed on an outer surface of the rotating member, and the inner thrust lip and the outer thrust lip have shapes complementary to the uneven structure and are capable of being in contact with the uneven structure.

11. The vehicle seat according to claim 1, wherein the cover includes a cylindrical portion, an end wall portion provided at one end of the cylindrical portion and having a shaft hole through which the operating shaft passes, a flange portion that protrudes radially outward from the other end of the cylindrical portion, and an edge wall portion that protrudes from the flange portion in a direction opposite to the cylindrical portion, and
the seal member is located in a housing space formed by the cylindrical portion, the end wall portion, the flange portion, and the edge wall portion, and held between the flange portion and the rotating member.

12. A method of producing a vehicle seat,
the vehicle seat comprising:
a seat cushion frame;
a seat back frame; and
a pivot device configured to connect the seat back frame angularly adjustably to the seat cushion frame,
the pivot device including:
a pair of rotating members that are rotatably connected to each other and form an outer shell of the pivot device;
a lock member disposed between the pair of rotating members and configured to move between a lock position, in which relative rotation of the pair of rotating members is restricted, and a release position, in which relative rotation of the pair of rotating members is permitted; and
an operating shaft that passes through central holes formed respectively in the pair of rotating members and is configured to rotate to displace the lock member between the lock position and the release position,
the method comprising:
mounting one of the pair of rotating members to the seat cushion frame;
mounting the other of the pair of rotating members to the seat back frame;
mounting a seal member on the operating shaft to seal a clearance between the operating shaft and each of the central holes by the seal member; and
mounting a cover on the operating shaft to hold the seal member between the cover and the rotating member.

13. The method of producing the vehicle seat according to claim 12, further comprising:
mounting an outer cover to the seat cushion frame; and
mounting a lever to the operating shaft that passes through the outer cover.
